(19) United States
(12) Patent Application Publication
(10) Pub. No.: US 2010/0161684 A1
(43) Pub. Date: Jun. 24, 2010

(54) STORAGE METHOD IN A DATABASE

(76) Inventor: Davide Zuccante, Milan (IT)

Correspondence Address: Gregory A. Nelson;Novak Druce & Quigg LLP, 525 Okeechobee Blvd, Suite 1500, West Palm Beach, FL, 33401, US

(21) Appl. No.: 12/593,167

(22) PCT Filed: Mar. 26, 2007
(86) PCT No.: PCT/IT07/00221

§ 371 Date: Feb. 23, 2010

(51) Int. Cl. G06F 7/00

(52) U.S. Cl. 707/812; 707/E17.044

(57) ABSTRACT

A storage method in a database comprising an insertion step of data and/or values (val-1a, val-2a, val-3b) in corresponding value rows (1; 2; 3) of at least one value table (5), a configuration step of a structure of the value rows (1; 2; 3) in configuration tables (9); the configuration step comprising the storage of a plurality of descriptive fields (desc-apar1, desc-apar2, desc-apar3, desc-apar4; desc-bpar1) of the value rows (val-1a, val-2a, val-3b) in a corresponding plurality of configuration rows in the configuration tables.

### FIELD OF APPLICATION

The present invention relates to a storage method in a database comprising a step of inserting data and/or values in corresponding value rows of at least one value table.

More in particular, the present invention relates to a method of above said type, in which in each row of said value table a plurality of information is stored.

### PRIOR ART

As is known, storage methods in a database comprise a step of storing a plurality of data and/or values in one or more storage tables of the database.

In particular, in the field of client/server applications, the database is stored in a central storage device or server connected to a plurality of user devices or clients through a network, for instance an internet connection of the wireline or wireless type.

In particular, the client/server applications are also known as rich-client applications, since the client comprises specific software for connecting to the server. The rich-client applications differ from the thin-client one in that they don't require a specific software for communication with the server, but use a browser and the known html protocol for accessing and modifying data.

The rise of new technologies has led to the birth of a third category of applications, namely the smart-client one, which is a natural evolution of the preceding. The smart-client applications allow the user to operate in a disconnected mode on his own data in a local manner, perusing the processing and visualization capabilities of his own device and synchronizing his own data with the server data, in an automatic way, as soon as a (wired or wireless) network connection with the server is available.

With reference to the client/server applications, the data are stored only on the server and are read and/or modified and/or inserted by the clients. To this end, each client comprises a client application to access data stored on the server, while the server comprises a server application for accepting the network connections from the clients and for managing the data access, for instance avoiding updating conflicts on the data which may rise when two or more clients simultaneously access the same data.

The client application generally comprises an interface for visualizing data stored on the server, for modifying or for inserting new data in the storage device of the server.

More in particular, in the case of smart-client applications, the data are transferred to the server only after their insertion in a local client memory, allowing therefore the user to consult or process the data, independently from the availability of a connection to the server. The smart-client application foresees the automatic transmission of data to the server, when a connection to the server is available, automatically and transparently to the user. These client applications-allow a user to consult or process data off-line, i.e. even in absence of a network connection with the server.

Such an off-line consulting or processing is indispensable when the client is a mobile device, i.e. a delocalized device, without a fixed and permanent power supply and network connection.

A mobile device is provided with its own power supply for operating, for instance during a trip, and with a network connection interface, which allows its connection to a network, when available.

On the contrary, when a network connection is unavailable, the mobile device operates in an off-line mode, using only its own resources for power, storage and processing.

An advantage of smart-client applications is the optimization of insertion and update time for data, since their transmission to the server is not accomplished at the time of saving through the visualization interface, but only when the network connection is available.

Nevertheless, the smart-client applications of above said type have some drawbacks which will become apparent from the following description.

Both client and server applications are provided for supporting a certain activity, for instance document managing. Such activities require a specific data storage, generally supported by a storage method comprising functions for defining relationships among data, corresponding access rights, operative flows as well as data types.

Nevertheless, it is clear that each activity requires specific variations of the modeling method, since it requires a specific data definition, their association to specific data types, a specific relationship among defined data, as well as a specific definition of data access rights, operative flows which determine a modification of respective values, to the point that storage methods supporting different activities are substantially different.

It is also known that, even in the same type of activity, different users require specific variants of the same method for storing data, sometimes rendering impossible or disadvantageous the use of the same storage method even in the same type of activity.

As an example, one consider a storage method of data supporting an activity in the health care sector, for instance the recording of personal data or data referring to the administration of cures to patients inside a hospital. The data comprise for instance personal patient information, his or her pathology, the prescribed cure or data related to the physician, to a group of health care personnel who administer the cure at different times during the day and similar data.

It is known that various professionals, operating in different health care structures, require that the storage method be adaptable to their own health care organization or to their own methodology, by means of a different data storage, for instance for supporting different operating flows.

For instance, two orthopedic sections of two different health care structures, require different storage methods due to different operative flows, working methodologies and data to be processed.

As is evident, these data are of the so called sensible type, as they pertain to the health status of the patient, and have therefore to be stored in respect of the privacy rules and are moreover important for recording the history of administration of the cure to the patient, as well as regarding the responsibilities associated to the single professionals who interact with the patient. Therefore a storage method for supporting a clinical activity requires a specific storage or data modeling technique.

Lastly, it is known to the skilled in the art that, with reference also to the same professional and to the same activity, it is difficult or at least not simple for the professional to preserve the same storage method, due for instance to requests of data modification or due to the relationship among these requests or the operative flows.

In some cases the variations to a storage method require high costs and long periods of time, due not only to the data complexity but also to an update of the client and server applications.

More particularly, an update to the client application requires that the mobile device be connected to the network, for receiving such updates or that its mass storage, comprising the client applications, be updated by means of corresponding updating devices.

Namely, if a version of the server application update is different from that for the client application, the final user may encounter problems in updating data or during the connection, especially because in the smart-client applications it is necessary to manage a data update, although not in real time, so that the data stored on the server correspond to the data shown by the client's visual interface.

The high dynamicity of many activities and the related need for modifications, results in an increasing difficulty in effectively managing the corresponding storage method. At the same time, experience shows that an alternative to the problem of dynamicity, i.e. the use of storage methods of generic data structures capable to adapt to every single exception of an activity to be supported, is not efficient since it is almost impossible, and costly, to foresee a totally adaptable modeling method.

Especially in the field of smart-client applications of said type, the use of generic data structures does not appear to be a good solution, neither from the performance nor from the storage capacity point of view, on the mobile device and server as well, and is disadvantageous with reference to the response time to data access requests.

Moreover, such a storage method appears to be disadvantageous also from an economic point of view, because of the analytic difficulties tied to the design of a storage method of generic data structures, coupled with the complexity of a certain activity.

Finally, a further problem connected to said storage methods is the fact that the most natural way to represent certain activities is based on data structures of the hierarchic documental type, i.e. structures which allow the definition of a substantially tree shaped data relationship, wherein said data may be generally represented by paper documents. However, the known storage methods, for instance storage methods for relational databases, are based on tabular representations which allow the definition of relationships among data of different tables, but hardly adapt to their modifications, although they allow the representation of a hierarchic documental data model.

In fact, although from the point of view of the final user a modification to a node of a representational tree of a hierarchic documental model appears to be easy, the translation of such a modification by means of the storage method based on relational databases potentially involves revising a plurality of relationships among tables in the database.

The modified tables, stored on the server, are potentially incompatible with the unmodified tables, for instance those stored on a client, by virtue of the modifications on data and relationships among data, with a consequent incompatibility among different versions of the applications stored on server and client.

The technical problem to be solved by the present invention consists in finding a storage method in a database, which is capable of storing a plurality of data and/or values in one or more tables of the database and of supporting substantial modifications to a structure of such tables, avoiding incompatibilities among the structures of obsolete tables, stored on one or more clients, and structures of updated tables, stored on a server, while providing a simple application of such structural modifications, overcoming the limitations and inconveniences which still today affect known storage methods.

### SUMMARY OF THE INVENTION

The solution concept on which the present invention is based consists in providing a storage method in a database for inserting a plurality of data and/or values in one or more value tables of the database, said method providing configuration of a structure of such value tables by means of configuration tables, substantially separating the step of storing values in the value tables, from the step of defining structures, which is provided in the configuration tables.

According to this solution concept, above said technical problem is solved by means of a storage method in a database comprising a step of inserting data and/or values in corresponding value rows of at least one value table, characterized in that it comprises the step of configuring a structure of value rows in configuration tables, said configuration step comprising the storage of a plurality of descriptive fields of the value rows in said configuration tables.

### BRIEF DESCRIPTION OF THE DRAWINGS

FIG. 1 schematically shows configuration tables and value tables provided according to the storage method of the present invention.

FIG. 2 shows a value table and two configuration tables provided by means of the insertion and the configuration step, respectively, for storing personal patient and medical prescription data, according to the storage method of the present invention.

FIG. 3 shows a value table and a configuration table provided by means of the insertion and configuration step, respectively, for storing generic data, according to the storage method of the present invention.

### DETAILED DESCRIPTION

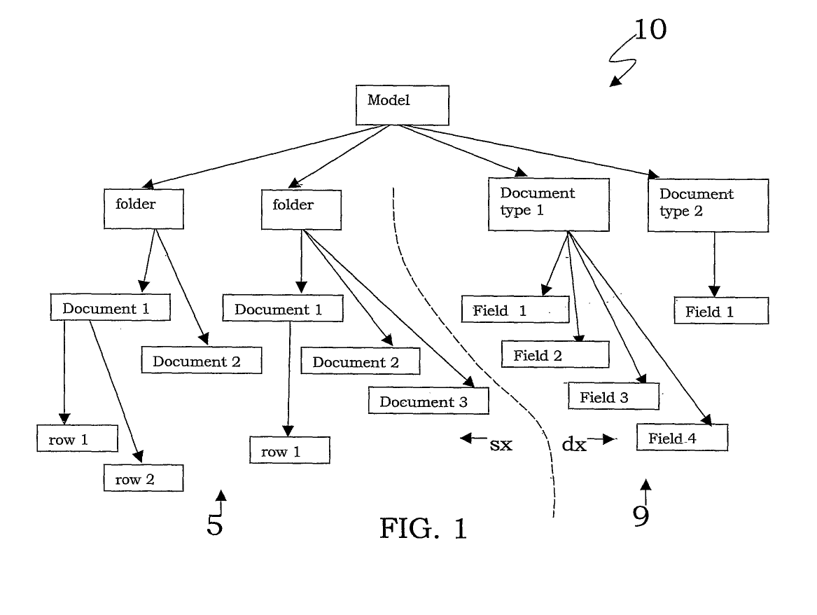

With reference to FIG. 1, the combined structure of value tables 5 and configuration tables 9, provided according to the storage method of the present invention, is generally and schematically indicated by reference numeral 10.

Since the storage method of the present invention is able to advantageously store data and/or values of the hierarchical documental type, namely data among which it is possible to establish a hierarchy of the father/child type, value tables 5 and configuration tables 9 are shown in a structure 10 by means of a tree representation.

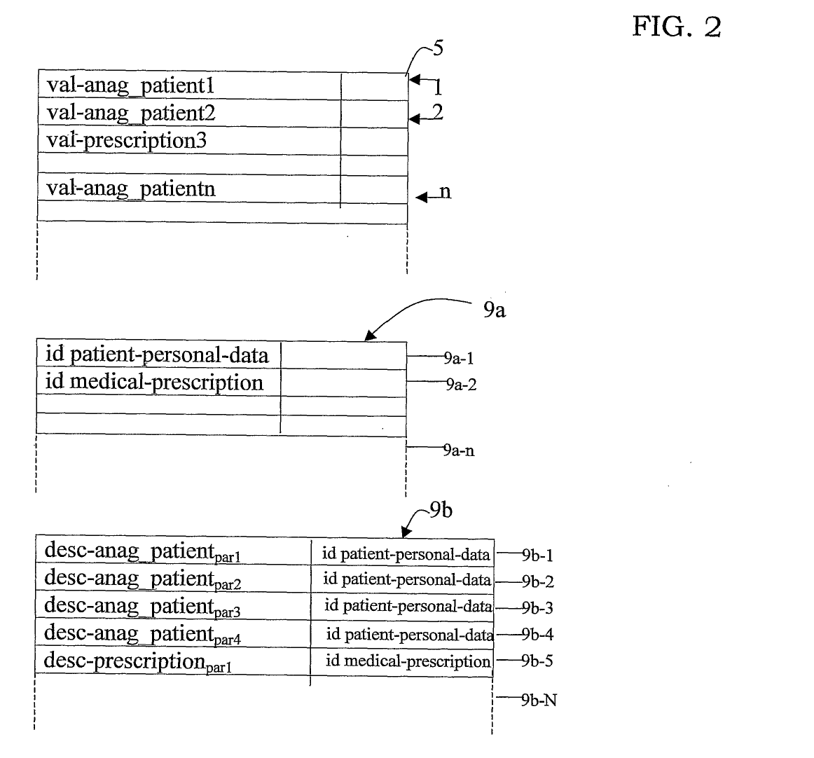

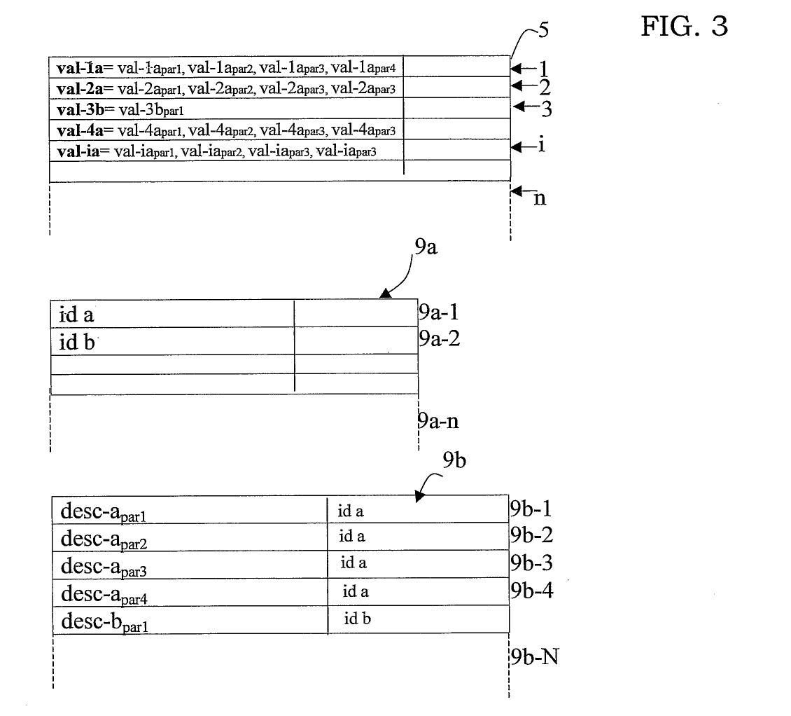

However, as will become apparent from the following description, in particular from FIG. 2-3, the storage method according to the invention comprises configuration and insertion steps of values in respective configuration tables 9 and value tables 5, which represent a possible implementation of the tree structure 10.

More in particular, the structure 10 comprises a root node “Model” connected to two different node typologies, corresponding to value 5 and configuration 9 tables, respectively.

The node “Model” is at the top of tree structure 10, comprising a plurality of child nodes directly connected to the root node “Model” or indirectly connected to it by means of a connection to another child node. In particular, the node “Model” is represented in FIG. 1, only for illustrative purposes, and represents the container of configuration and value table according to the storage method of the invention.

The child node “document type 1” is directly connected to the root node “Model” while child node “field 1” is directly connected to child node “document type 1”.

For illustrative purposes and without any limitation to the scope of the present invention, the storage method is described with reference to the storage of a plurality of data, supporting a monitoring activity for patients inside a health care structure.

For instance, the child node “document type 1” represents a document of type “personal data”, namely a collector of information which may be associated to the patient's personal data while the child nodes “field 1”, “field 2”, “field 3” represent for instance the information which may be associated to the document of type “personal data”, such as surname, name, age, weight of a patient, and others.

In similar way, child node “document type 2” represents a document of type “medical prescription”, namely a collector of information which may be associated to a medical prescription, while child nodes “field 1”, “field 2” represent the information which may be associated to the medical prescription, suck as the name of the drug to be administered and the administration time for said drug.

According to the storage method of the present invention, the nodes “document type 1”, “document type 2” and respective children do not contain any value, i.e. personal data associated to a specific patient or data regarding a specific medical prescription, but are the description of the possible values of these data and the constraints imposed on said values.

For instance, node “field 2”, regarding a document of type “medical prescription”, may specify the administration time of a drug and may specify that the time of administration has to be expressed in the format of numerals, but not of alphanumeric characters.

Node “field 2” may contain a plurality of other conditions or information which may be associated to the time of administration of the drug, which are in the following called configuration parameters.

As mentioned above, the storage method of the invention stores the nodes “document type 1”, “document type 2” and respective children of structure 10 by means of configuration tables 9.

The configuration tables 9 specify the data structures that may be associated to the personal data of a patient and the data structures that may be associated to a medical prescription, without specifying any value.

More in particular, the storage method of the invention comprises a step of generating the configuration tables 9 in a relational database. For further clarity, let's consider a document type “patient_personal_data” for recording patient information as “surname”, “name”, “age”, “weight”. This document of type patient's personal data is described by means of configuration rows stored inside the configuration tables 9, as will become apparent from the following description.

More in particular, in the case of above said example, configuration rows “surname”, “name”, “age”, “weight” in configuration tables 9 specify that a patient, i.e. a document of type personal data, comprises information regarding “surname”, “name”, “age”, “weight” of a patient. However, by using for instance the teachings of object programming, known per se, it is possible to represent node “document type 1” as a class and child nodes “field 1”, “field 2”, “field 3” as its sub-classes or attributes.

According to a preferred embodiment of the present invention, the configuration step foresees the generation of two configuration tables 9a and 9b, used to describe the structure of a value table 5.

With reference to FIG. 2, a first configuration table 9a is shown, which comprises configuration rows 9a-1, 9a-2 for storing an identifier for Personal_Data and an identifier for Prescription, respectively, corresponding to nodes “document type 1” and “document type 2” respectively.

In FIG. 2 a second configuration table 9b is shown, which comprises a plurality of configuration rows 9b-1, 9b-2, 9b-3, 9b-4, corresponding to nodes “field 1”, “field 2”, “field 3”, “field 4” of FIG. 1.

The relationship between the nodes “node type 1” and nodes “field 1”, “field 2”, “field 3”, “field 4” is provided trough a relationship between the first and second configuration table 9a and 9b. By means of identifier for Personal_Data in table 9a it is indeed possible to identify all the rows of configuration table 9a associated to Personal_Data.

A second configuration row 9a-2 in table 9a stores for example an identifier for a medical prescription, corresponding to node “document type 2” of FIG. 1, while the second configuration table 9b comprises a configuration row 9b-5, corresponding to node “field 1” of FIG. 1 and related in this example to the description of the prescription.

The structure of the content of value table 5 is represented by configuration tables 9a and 913. As shown in FIG. 2, each row of values in value table 5 stores data according to the description stored in configuration tables 9a and 9b.

For instance, rows of values 1 . . . n in value table 5 comprise a plurality of values “val_anag_patient 1”, “val_anag_patientn” which conform to conditions and parameters provided by configuration rows of table 9b, i.e. conditions and parameters desc-anag_patientpar1, desc-anag_patientpar2, desc-anag_patientpar3, desc-anag_patientpar4.

Similarly, rows of values 1 . . . n in value table 5 comprise a plurality of values “val_prescription1”, val-prescription” which conform to conditions and parameters of configuration rows of table 9b, in the example shown, condition desc-prescriptionpar1.

According to the configuration method of the invention, the number of configuration tables 9 may be greater than two. In this case, the number of in-direction levels used for representing the structure of value table 5, by means of configuration tables 9, is greater than two.

As described above, in the preferred embodiment of the invention, only one value table 5 is used to store all the values described by different configuration rows. In other words, value table 5 stores data pertaining to different document types in the value rows.

However, according to the storage method, it is possible to insert values in more than one value table 5, for instance corresponding to different data types.

In a similar way, according to the storage method of the present invention, the number of nodes connected to the root node “Model” is defined during the configuration step. Obviously, the greater the number of connected nodes to a node “document type”, the greater will be the number of corresponding configuration rows 9b-1, 9b-2 in configuration table 9.

In particular, during the configuration step, the number of nodes “document type X” is defined; this number may be changed by means of the storage method, in order to modify the data modeling and therefore the way an activity is represented. As said, the storage method comprises an insertion step of values in the value tables 5. The configuration tables provided during the configuration step generally describe the structure of such tables.

With reference to FIG. 1, value table 5 provides a representation of inserted values. The node Row 1 of Document 1 represents and stores a sequence of values described by nodes “field 1”, “field 2”, “field 3”, “field 4”, that are children of node “document type 1”.

More in detail, such insertion step comprises the generation of value table 5, as described by the corresponding configuration tables 9. The insertion step comprises also the storage of one or more values in value table 5.

Advantageously, the values stored in value table 5 are separated from the structure, which is stored in configuration tables 9; these tables 9 don't contain any value and are used to map the content of value table 5.

For instance, node “document 1” may store data “Paolo”, “Rossi”, “1.80”, “75” in a single row. With reference to the possible storing of nodes of configuration tables 9 as classes, according to object programming, node “document 1” is defined as an object, i.e. an instance of a class “document type 1” while node “row 1” comprises one or more objects or attributes, instances of sub-classes or attributes “field1”, “field2”, “field3”.

Still referring to activities inside a health care structure, if a modification to a structure defined by configuration tables 9 is required, for instance because a physician wants to store an information which was not already present from the beginning, such as the patient's eye color, deciding to associate such information to the patient's personal data, the storage method of the present invention provides a configuration step of an additional child node, for instance node “field 4”, which may be associated to father node “document type 1”, in turn associable to the information “eye color”.

Said configuration step has to be understood more generally as a modification step of configuration tables 9, since a child node, already present, may be modified. After the configuration step, the insertion step allows the association of eye color to a specific patient.

The modification of configuration tables 9 of the server may be also provided on one or more clients, by means of a general updating procedure, comprising a configuration step for the client. The modification of configuration tables 9 of the server is afterwards applied to the clients, by means of a general updating-procedure similar to the one provided for data insertion.

Advantageously, the insertion step of a new row to document type “personal data” by means of an updated client, with respect to the server, allows the insertion of all data described by configuration tables 9 on the server, including the patient's eye color; an updated client is therefore able to insert a new row of values in value table 5, comprising values “Piero”, “Franti”, “1.69”, “64”, “green”.

This updated client is moreover allowed to insert eye color in the row of the document of personal data “Paolo”, “Rossi”, “1.80”, “75”, i.e. it may define a value of zero. This value is zero because the corresponding row of values was inserted before the configuration tables 9 would describe such a value.

On the contrary, an un-updated client will not be able to visualize and modify the information related to eye color.

Advantageously, the modification of a document of type “Personal Data” provided by above said storage method, allows an un-updated client to visualize and update all data visible to the same client, without encountering any incompatibility issue, since value table 5 updated or modified by the client is structurally identical, since its structure is described by configuration tables 9.

The storage method of the present invention also allows reserving one or more additional system columns in value table 5.

Such additional system columns are not used for storing values but for storing system data, for instance the relationship between nodes, a row identifier, an insertion date, the version number of the same row, the name of the person responsible for the insertion.

In particular, the row identifier identifies the type of document to which the stored data pertain in the row, depending on the identifier stored in configuration rows 9a-1, 9a-2 of configuration table 9a.

Each single row of values comprises a storage column, containing a plurality of values, which are for instance separated by a separator element, the configuration parameters of each value in the row being defined by a corresponding configuration row 9b-1, 9b-2 of configuration table 9b.

The storage method according to the present invention may be applied for storing data in a client application as well as for storing data in a server application.

In particular, if the version of the client application is updated with respect to the server application, no compatibility problems or data malfunctions are encountered. Supposing that the client application has not been updated by the configuration step, which introduced the patient's eye color, this information is not visualized by the visualization interface in the client application.

Nevertheless, the client application is still able to communicate with the server.

Advantageously, the update of a server application does not require a connection interruption between client and server. This is due to the fact that an application update is accomplished through the configuration step, only involving configuration tables 9, which do not store data.

In the following description, some embodiments of the present invention are described in order to underscore some of the most important advantages of said storage method.

In a first embodiment, the storage method comprises the use of two different value tables 5 for storing values. A first value table for “current” data and a second value table for “chronology” data, called current value table and archival value table, respectively.

More particularly, the first and second value tables are both structured on the basis of the configuration tables 9, comprising a column for storing a plurality of data and the same number of additional system columns.

The rows of values of value tables 5 comprise information like: row identifier, version identifier for the row of values, the sequence of stored values in the row of values, etc.

The use of the first and second value table 5 according to the method of the invention allows to store all the operations on rows and to store the states of a row due to modifications, in other words it allows the reconstruction of the history of each row, beginning with its first insertion until its last modification or logic cancellation.

In particular, for each modification request, the storage method executes an insertion step of a new row in the value table, comprising all values stored in the corresponding row of the current value table to be modified.

More particularly, the storage method envisages the storage of some additional values in the row of values of the value table, comprising information relating to the date of insertion, time of insertion, the name of the user who has requested the modification and a unique identifier.

In this way, the storage method automatically provides an indication about the level of updating of data, associating the data operations to persons who have requested and executed such operations, permitting to determine the time of execution of a determined operation. Such indicative values of updating of data are also included in the row of values of the current value table.

The insertion step finally modifies the row of values in the current value table.

In other words, a modification request for a row into the current value table comprises a step of insertion into the filed value table and a successive updating step of one or more values of the row of values of the current value table. The updated row in the current value table contains the modified values and a plurality of information such as date and time of modification, the name of the user who has applied the modification, a unique identifier, and other data.

Advantageously, the table of current values stores only updated values, while the filed value table stores all the preceding versions, including the whole chronology of modifications applied to each row.

As already stated above, the storage method of the invention is advantageous, because the configuration tables 9 easily modify the structure of values stored in the value tables 5 (for instance by adding the reference to the height of a patient).

Such easy modification is more evident when related to storage methods of the known art, in which the modification of the structure of one table requires the execution of one or more commands (for instance SQL).

These commands are executable only with specific rights to access the database in which the tables are stored, in general administrator privileges, for instance for adding a column to a table of the database.

Advantageously, according to the method of the invention, a modification to the data structure of value table 5 is executed by means of insertion of one or more rows into the configuration tables 9, wherein this operation may be executed without administrator privileges for the database.

The storage method provides various advantages in data synchronization, i.e. when a database stored on the server has to be synchronized to a database stored on one or more clients, so that structure and contents of the tables in respective databases may be substantially the same.

In fact, according to a storage method of the known art, adding a column to a table which is synchronized between server and client, requires complex procedures, normally executed by skilled operators, with a heavy impact on client applications and respective users, while according to the storage method of the present invention, the structure of value tables 5 remains substantially unaffected.

In fact, the value table 5 stores values in a single column and stores system information in additional columns, while a variation in the configuration tables 9 is accomplished by adding one or more rows.

Advantageously, according to the storage method of the present invention, the configuration step on configuration tables 9 may be executed on the server, during normal client operation.

The steps of the storage method in a database according to the present invention are now described with particular reference to FIG. 3.

More particularly, the storage method comprises:
an insertion step of data and/or values val-1a, val-2a, val-3b into corresponding rows of values 1, 2, 3 of a value table 5;
a configuration step of a structure of value rows 1, 2, 3, in configuration tables 9, the configuration step comprising the storing of a plurality of descriptive fields desc-apar1, desc-apar2, desc-apar3, desc-apar4; desc-bpar1 of value rows 1, 2, 3 into said configuration tables.

The configuration step comprises the storing of more than one configuration table 9, in particular a first and a second configuration table 9a, 9b.

The second configuration table 9b comprises configuration rows 9b-1, 9b-2, . . . 9b-N for storing the descriptive fields desc-apar1, desc-apar2, desc-apar3, desc-apar4; desc-bpar1.

The configuration step further envisages storing a corresponding identifier or key in one or more configuration rows 9a-1, 9a-2 of the first configuration table 9a. More particularly, the same configuration row in configuration table 9a may refer to a plurality of configuration rows 9b-1, 9b-2, . . . 9b-N of configuration table 9b.

In fact, several configuration rows 9b-1, 9b-2 of second table 9b may store the same identifier or key of a configuration row 9a-1 of the first configuration table 9a. In this way, several configuration rows of table 9b are associated to only one configuration row of table 9a, in order to express their belonging to a same logic document, represented by this configuration row 9a.

One or more configuration rows 9b-1, 9b-2, 9b-N storing the same identifier are used in the insertion step for inserting a plurality of values val-1a, val-2a, val-3b in a value row of value table 5.

The insertion step envisages the insertion of one or more values val1-apar1, val-1apar2, val-1apar3, val-1apar4 in row 1 of values val-1a of table 5 of FIG. 3 in each row 1 of values val-1a.

This insertion step is similarly executed on a plurality of rows of value table 5, for instance for inserting the value with index I val-iapar1, val-iapar2, val-iapar3, val-iapar4 into row 1 of values val-ia of table 5 in FIG. 3.

The number of values in each row 1 of values val-1a is associated to a number of descriptive fields desc-apar1, desc-apar2, desc-apar3, desc-apar4 in the second configuration table 9b, stored in corresponding configuration rows 9b-1, 9b-2, 9b-3, 9b-4.

The insertion step comprises a verification step of values val-1a, with respect to descriptive fields desc-apar1, desc-apar2, desc-apar3, desc-apar4.

The insertion step into value table 5 comprises the storing of a row identifier in one or more additional system columns of value table 5, for instance the insertion date, the row version number, the name of the author of the insertion.

Data and/or values are sensible data, for instance patient's data in a health care structure, and for each data it is necessary to be able to track the history of modifications.

The configuration step of configuration tables 9a, 9b may be executed on a network computer of the server type, during the normal operation of one of the network client computers.

The configuration step is valid for all nodes “document type XX” and the insertion step is valid for all nodes “document XX”, since all nodes “document XX” share table 5 and tables 9a and 9b are shared by all nodes “document type XX”.

In other words, tables 9 contain the description of all types of documents, described in the model which is to be stored by means of the storage method, while table 5 contains all rows of all documents stored in said model.

In particular, table 5 stores among the system columns, one column which contains an identifier of the document type, in order to determine the configuration of node “row Y” stored by corresponding rows of configuration tables 9a, 9b.

The storage method of the present invention further comprises a development interface, which allows a programmer to execute the insertion and configuration step through a plurality of functions for inserting and updating data, for creating relationships among them and/or to establish operative flows on data.

More particularly, the development interface comprises a plurality of functions for:
hiding from the developer the configuration and insertion steps, simplifying the understanding of value and configuration tables,
providing the developer with an access to data typical of object oriented programming, representing a relationship or a data interaction by means of objects,
automatically providing the insertion into tables of values of information related to modifications applied in the course of time on a value row.

The storage method according to the present invention further supports sensible data encryption, for instance clinical data of patients of a health care structure. By using the system columns of configuration tables 9, the storage method of the invention provides a mean for determining if and which data are to be encrypted according to encryption algorithms, which are known per se.

Data encryption is required in various fields, as in the medical field as well as in the financial sector, for insuring that stored data are accessible only by applications generated by the development interface provided by the storage method of the invention. This method is furthermore able to transparently manage encryption/decryption data operations for the client and server applications.

The storage method according to the present invention moreover supports work flow management on data stored in the value table 5, by defining relationships among nodes of type “document type 1” and storing information related to modifications which are introduced in the course of time on such nodes.

In other words, the storage method according to the present invention is also able to manage a plurality of operative processes. For instance, in a process comprising the steps of activity request, activity approval and activity execution, it is possible to express the work flow by means of three nodes of type “document”, associated to the three steps and by means of a node of type “row”.

The storage method of the present invention provides the definition of a workflow by means of a configuration table regarding relationships of the father/child type among the nodes “document type X”. More particularly, the additional system columns in value table 5 comprise the storage of relationship information among said nodes.

The relationship is expressed between the two rows of value table 5 and allows the navigation from father node to child node, i.e. between different rows of value table 5. For instance, it is possible to determine a relationship between a document of the medical prescription type and a document of the administering type, in order that a row containing data related to a medical prescription be connected to a row containing data related to administering the drug by the operator. More particularly, in the initial state, the node of type “row” is associated to “document” which represents the final step, i.e. the “activity request”. In other words, a node of type “row” is a row of values of value table “activity request”. The state change is accomplished by an insertion step of the node of type row in the value table “activity approval”.

The workflow management is also facilitated by a management interface similar to said development interface. In particular, the management interface provides:
workflow design,
state management by client or server applications,
management of possible integration on server with external systems.

The workflows also comprise the interaction with humans and are able to manage situations in which processes last for various days. In this case, the state of a process may be stored and reactivated when the operator is ready to execute an associated activity.

1. Storage method in a database, comprising an insertion step of data and/or values (val-1a, val-2a, val-3b) in corresponding value rows (1; 2; 3) of at least one value table (5), characterized by comprising a configuration step of a structure of said value rows (1; 2; 3) in configuration tables (9), said configuration step comprising the storage of a plurality of descriptive fields (desc-apar1, desc-apar2, desc-apar3, desc-apar4; desc-bpar1) of said value rows (val-1a, val-2a, val-3b) in said configuration tables (9).

2. Storage method according to claim 1, characterized in that said configuration step comprises the storage of a first and a second configuration table (9a, 9b), said descriptive fields (desc-apart, desc-apar2, desc-apar3, desc-apar4; desc-bpar1) being stored in configuration rows (9b-1, 9-b-2, 9b-3) of said second configuration table (9b).

3. Storage method according to claim 2, characterized in that said configuration step comprises the storage, in the configuration rows (9a-1, 9a-2) of said first configuration table (9a), of a corresponding identifier of at least a configuration row (9b-1, 9b-2, 9b-3) of said second configuration table (9b).

4. Storage method according to claim 3, characterized in that said configuration step comprises the storage of said corresponding identifier in one or more configuration rows (9b-1, 9b-2, 9b-3) of said second configuration table (9b).

5. Storage method according to claim 4, characterized in that said insertion step comprises the fact that a value (val-1a) in a value row (1) comprises a plurality of values (val-1apar1, val-1apar2, val-1apar3, val-1apar4), a number of values in said value row being associated to a number of descriptive fields (desc-apar1, desc-apar2, desc-apar3, desc-apar4) in said second configuration table (9b) for said value row.

6. Storage method according to claim 5, characterized in that said insertion step comprises a verification step of said plurality of values (val-1apar1, val-1apar2, val-1apar3, val-1apar4) with respect to said descriptive fields (desc-apar1, desc-apar2, desc-apar3, desc-apar4).

7. Storage method according to claim 6, characterized in that said insertion step in said value table (5) comprises the storage, in one or more additional system columns of said value table (5), of a row identifier, corresponding to said corresponding identifier stored in said configuration table 9a.

8. Storage method according to claim 7, characterized in that said additional system columns comprise an insertion date, a row version number, the name of the person responsible for the insertion.

9. Storage method according to claim 1, characterized in that said data and/or values are sensible data, patient data in a health care institution.

10. Storage method according to claim 1, characterized in that said configuration step of the configuration step (9) may be executed on a network computer of the server type during normal operation of one of the network computer of the client type.

11. Storage method according to claim 4, characterized in that said at least one value table (5) comprises at least one current value table and one filed value table, a modification request on a row in said current value table being executed by means of an insertion step of a row of values in said filed value table, for storing the stored values in said row said current value table, and a successive modification of said value row in said current value table.
